(19) United States
(12) Patent Application Publication
(10) Pub. No.: US 2013/0158282 A1
(43) Pub. Date: Jun. 20, 2013

(54) POLYHEDRAL OLIGOMERIC SILSESQUIOXANE (POSS) BONDED LIGANDS AND THE USE THEREOF

(71) Applicants: Andrea Christiansen, Neu-Ulm (DE); Robert Franke, Marl (DE); Dieter Hess, Marl (DE); Dirk Fridag, Haltern am See (DE); Dieter Vogt, Nuenen (NL); Christian Mueller, Berlin (DE); Michele Janssen, Eindhoven (NL)

(72) Inventors: Andrea Christiansen, Neu-Ulm (DE); Robert Franke, Marl (DE); Dieter Hess, Marl (DE); Dirk Fridag, Haltern am See (DE); Dieter Vogt, Nuenen (NL); Christian Mueller, Berlin (DE); Michele Janssen, Eindhoven (NL)

(73) Assignee: Evonik Oxeno GmbH, Marl (DE)

(21) Appl. No.: 13/582,265

(22) PCT Filed: Mar. 1, 2011
(86) PCT No.: PCT/EP11/52957

§ 371 Date: Mar. 11, 2013

(30) Foreign Application Priority Data
Mar. 1, 2010 (EP) 10155095.2

(51) Int. Cl. B01J 31/06

(52) U.S. Cl. CPC B01J 31/06
USPC 556/460; 502/158; 252/183.13; 568/451

(57) ABSTRACT

The present invention relates to POSS-modified ligands and to the use thereof in catalytically effective compositions in hydroformylation.

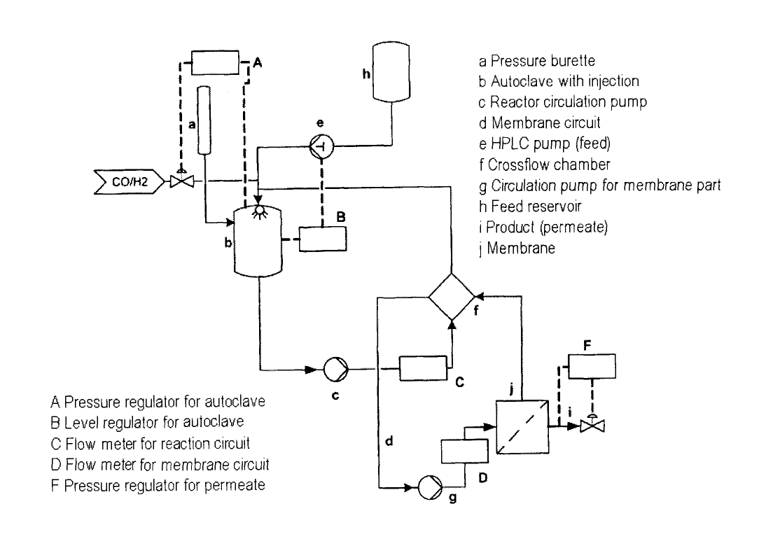

The hydroformylation of olefins and olefin-containing mixtures are a subject of research in the chemical industry. An ongoing objective in catalytic hydroformylation is retention of the activity and selectivity of the catalytically active compositions used in respect of the olefins and olefin-containing mixtures to be hydroformylated under the reaction conditions. In particular, in the case of transition metal-containing, catalytically active compositions, it is an object of research to prevent or at least significantly decrease the inhibition of the catalytic effect, the formation of transition metal clusters and the precipitation of the transition metal itself. The present invention makes a contribution to this objective by showing a way of, in a simple way, separating the desired target products from the catalytically active composition while retaining the catalytic activity of the latter and avoiding thermal stress on the reaction mixture.

The present invention provides POSS-modified ligands, where POSSs are polyhedral oligomeric silsesquioxane derivatives. The polyhedral oligomeric silsesquioxane derivatives used are reacted with ligand precursors known per se. The resulting POSS-modified ligands have a greatly increased molecular weight compared to unmodified ligands. In an embodiment of the invention, an alkylphenyl-substituted, in particular an ethyl-phenyl-substituted, POSS-substituted triphenylphosphine derivative is prepared from triorganophosphines such as triphenylphosphine:

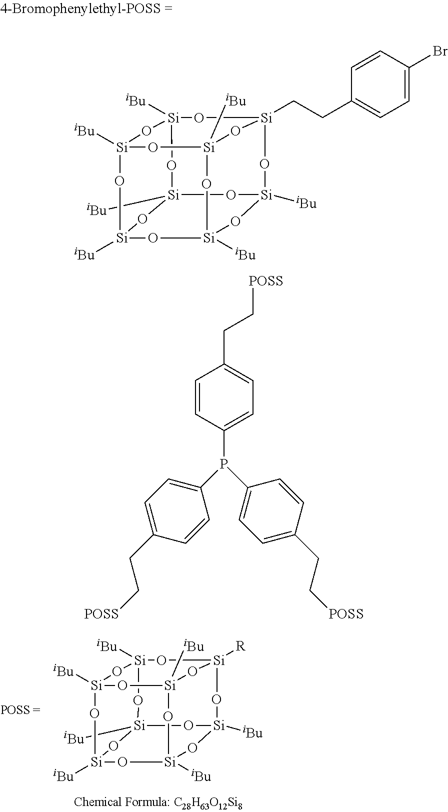

### Preparation of POSS-Substituted Triphenylphosphine

4-Bromophenylethyl-POSS (11 g, 10.92 mmol) is dissolved in 100 ml of THF and cooled to −78° C. n-BuLi (2.5 M in hexane, 4.8 ml, 12 mmol) is added dropwise and the reaction mixture is stirred at this temperature for 1 hour. PCl₃ (0.5 g, 3.64 mmol) is added dropwise. The reaction mixture is allowed to warm to room temperature and is stirred overnight. The solvent is removed under reduced pressure. The reaction product is extracted from the remaining solid with toluene-hexane (1:1, 150 ml) and washed with degassed water. The organic phase is dried over MgSO₄. The solvents are removed under reduced pressure. The product is obtained as a white solid in a yield of 78% (8 g, 2.84 mmol).

¹H NMR δ (ppm): 7.24 (dd, J=12.4 Hz, J=14.4 Hz, 12H), 2.69 (m, 6H), 1.87 (sept, J=6.7 Hz, 7H), 0.97 (d, J=6.6 Hz, 42H), 0.62 (d, J=7 Hz, 14H)

13C NMR δ (ppm): 145.15, 133.83, 127.94, 125.61, 28.97, 25.70, 23.88, 22.53, 14.07

31P NMR δ (ppm): −7.76 (s)

Maldi-Tof: m/z=2809.07 (M+Na)

Elemental analysis: calculated (found): C 46.45 (46.54), H 7.69 (7.77)

The present invention further provides transition metal-containing compositions which can be obtained by reaction of the POSS-modified ligands with suitable transition metal precursors and are catalytically active in the hydroformylation of olefins and olefin-containing mixtures. A characteristic of these novel transition metal complexes prepared using POSS-modified ligands in the catalytically active compositions is that the activity and selectivity are maintained compared to the transition metal complexes which have not been modified with POSS. At the same time, the catalytically active compositions according to the invention can be separated off completely from the reaction mixture by means of organic nanofiltration and can be recirculated to the hydroformylation reaction. In one embodiment of the invention, the above-described POSS-substituted triphenylphosphine is reacted with a rhodium-containing, suitable transition metal precursor, e.g. [Rh(acac)(CO)₂], to form the catalytically active composition.

The present invention further provides for the use of POSS-modified ligands in catalytically active compositions in the hydroformylation of olefins and olefin-containing mixtures. In an embodiment of the invention, the above-described POSS-substituted triphenylphosphine is reacted with a rhodium-containing, suitable transition metal precursor, e.g. [Rh(acac)(CO)₂], to form the catalytically active composition which is used in the hydroformylation of olefins such as 1-octene:

### EXAMPLE 1

### Hydroformylation of 1-Octene in a Continuously Operated Membrane Reactor

The hydroformylation experiments were carried out in a continuously operated experimental plant; see sketch of plant. This experimental plant consisted of a reaction part and a membrane part. The reaction part comprised a 100 ml autoclave b with a circulation pump c. The autoclave b was equipped with a pressure regulator A for the synthesis gas. By means of this pressure regulator A, the synthesis gas pressure was kept constant in the entire system during the reaction. The synthesis gas uptake of the system was determined by means of a flow meter C. For the introduction of feed and catalyst solutions before the start of the reaction, the reactor was equipped with a pressure burette a which could be supplied with synthesis gas and thus allowed introduction of the feed and catalyst solutions under reaction conditions. The autoclave b was additionally equipped with a level regulator B. The feed pump e was controlled by this level regulator B and then pumped feed solution comprising the olefin-containing mixture, optionally solvent, from a reservoir h into the autoclave b so as to keep the level in the autoclave constant. This feed reservoir h was blanketed with argon to avoid contact with air. The necessary turbulence in the autoclave was generated by the circulation pump c which itself was constructed for this purpose. The pump c built up circulation of the reaction solution via a nozzle in the top of the autoclave b and thus ensured appropriate gas/liquid exchange. The synthesis gas and the feed were likewise fed into the nozzle.

A crossflow chamber f was likewise installed in this circuit. The crossflow chamber f separates the reaction part from the membrane part of the plant.

The crossflow chamber f brings about mixing of the membrane circulation with the reactor output and ensured that the free gas in the outlet from the reactor could not get into the membrane part but instead was recirculated to the reaction circuit.

The membrane part comprised a pressure tube which contained a ceramic membrane j having a length of 200 mm and a specific filter area of 0.0217 m²/m and a cutoff of 450 D and a circulation pump g which generated circulation over the membrane. The connection to the reaction part was effected via the above-described crossflow chamber f.

The permeate flow through the membrane j was brought about by a pressure regulator F on the permeate side. This regulator made it possible to build up a pressure difference over the membrane area and thus produce a product flow i of aldehydes.

Before the start, the reaction system was pressurized five times with 2.0 MPa of synthesis gas CO/H₂ (1:1) and depressurized each time. The feed solution (1.9 M 1-octene in toluene) was then transferred by means of an HPLC pump from the above-described feed reservoir h into the experimental plant b to 90% of the desired fill level. After start-up of the reactor circuit, the reaction part was heated to 80° C. and a pressure of 2.0 MPa of CO/H₂ (1:1) was set. The reaction system was equilibrated for 1 hour before the catalytically active composition containing 15 mg (58 μmol) of Rh(acac)(CO)₂ and 815 mg (290 μmol) of the POSS-substituted PPh₃ according to the invention, corresponding to an L:Rh ratio of 5:1, in 14 ml of toluene was introduced via the above-described pressure burette a (t=0) under the reaction pressure. The catalyst solution was made up under an argon atmosphere. A differential pressure TMP of 0.35 MPa was subsequently set at the membrane j by means of the permeate pressure regulator F in order to remove the product i, aldehydes, formed from the system. The amount of product i discharged was then replaced by feed solution from the reservoir h by means of the above-described level regulator B on the autoclave and the fill level in the reaction system was thus kept constant. The reaction was carried out for a period of 14 days; during this time, samples were taken and analyzed at regular intervals. The conversion of 1-octene and the regioselectivity (l/b ratio) were determined by means of GC analysis. Rh and P retentions by the membrane were determined by ICP-OES analysis of the permeate. Both the Rh losses and the P losses were very small. Based on the total amount of rhodium and phosphorus, these losses were 0.07% (Rh) and 0.97% (P).

Continuous hydroformylation of 1-octene; specifications

| | |
|---|---|
| Reaction volume | 220 ml |
| Reaction temperature | 80° C. |
| Reaction pressure | 2.0 MPa CO/H₂ (1/1) |
| [Rh] | 0.26 mM |
| [1-Octene] | 1.9M |
| Solvent | Toluene |
| L:Rh | 5:1 |
| Reactor circulation | 0.45 l/min |
| Membrane circulation | 2.27 l/min |
| Membrane | Manufacturer = Inopor |
| | Material = TiO₂ |
| | Length = 200 mm |
| | di = 7 mm |
| | da = 10 mm |
| | Pore size = 0.9 nm |
| | Filtration area = 0.0217 m²/m |
| | cutoff = 450 D |
| TMP | 0.35 MPa |
| Permeate flow | 10 g/h |

Continuous hydroformylation of 1-octene using POSS-
substituted PPh₃/Rh

| Sample | Time (min) | Yield (%) | l/b |
|---|---|---|---|
| 1 | 0 | 0 | |
| 2 | 10 | 0.0 | |
| 3 | 20 | 1.3 | |
| 4 | 30 | 4.0 | 2.8 |
| 5 | 40 | 6.9 | 2.8 |
| 6 | 50 | 10.3 | 2.8 |
| 7 | 60 | 13.6 | 2.8 |
| 8 | 70 | 17.3 | 2.8 |
| 9 | 80 | 20.8 | 2.8 |
| 10 | 90 | 23.5 | 2.8 |
| 11 | 100 | 27.4 | 2.8 |
| 12 | 110 | 30.5 | 2.8 |
| 13 | 120 | 34.2 | 2.8 |
| 14 | 140 | 40.7 | 2.8 |
| 15 | 160 | 46.8 | 2.8 |
| 16 | 180 | 52.1 | 2.8 |
| 17 | 240 | 67.6 | 2.8 |
| 18 | 300 | 79.9 | 2.8 |
| 19 | 360 | 89.7 | 2.8 |
| 20 | 420 | 90.3 | 2.8 |
| 21 | 1020 | 95.8 | 2.5 |
| 22 | 1080 | 95.7 | 2.5 |
| 23 | 1140 | 95.6 | 2.5 |
| 24 | 1200 | 95.7 | 2.5 |
| 25 | 1260 | 95.8 | 2.5 |
| 26 | 1620 | 96.0 | 2.5 |
| 27 | 2490 | 96.3 | 2.4 |
| 28 | 3030 | 96.1 | 2.3 |
| 29 | 3930 | 96.2 | 2.3 |
| 30 | 5650 | 96.4 | 2.3 |
| 31 | 7050 | 96.5 | 2.3 |
| 32 | 8680 | 96.7 | 2.3 |
| 33 | 11590 | 96.4 | 2.4 |
| 34 | 14260 | 95.2 | 2.3 |
| 35 | 17450 | 93.5 | 2.3 |
| 36 | 19620 | 90.5 | 2.3 |

### EXAMPLE 2

### Hydroformylation of l-Butene in a Continuously Operated Membrane Reactor

The hydroformylation experiments were carried out in a continuously operated experimental plant; see sketch of plant. This experimental plant consisted of a reaction part and a membrane part. The reaction part comprised a 100 ml autoclave b with a circulation pump c. The autoclave b was equipped with a pressure regulator A for the synthesis gas. By means of this pressure regulator A, the synthesis gas pressure was kept constant in the entire system during the reaction. The synthesis gas uptake of the system was determined by means of a flow meter C. For the introduction of feed and catalyst solutions before the start of the reaction, the reactor was equipped with a pressure burette a which could be supplied with synthesis gas and thus allowed introduction of the feed and catalyst solutions under reaction conditions. The autoclave b was additionally equipped with a level regulator B. The feed pump e was controlled by this level regulator B and then pumped feed solution comprising the olefin-containing mixture, optionally solvent, from a reservoir h into the autoclave b so as to keep the level in the autoclave constant. This feed reservoir h was blanketed with argon to avoid contact with air. The necessary turbulence in the autoclave was generated by the circulation pump c which itself was constructed for this purpose. The pump c built up circulation of the reaction solution via a nozzle in the top of the autoclave b and thus ensured appropriate gas/liquid exchange. The synthesis gas and the feed were likewise fed into the nozzle.

A crossflow chamber f was likewise installed in this circuit. The crossflow chamber f separates the reaction part from the membrane part of the plant.

The crossflow chamber f brings about mixing of the membrane circulation with the reactor output and ensured that the free gas in the outlet from the reactor could not get into the membrane part but instead was recirculated to the reaction circuit.

The membrane part comprised a pressure tube which contained a ceramic membrane j having a length of 200 mm and a specific filter area of 0.0217 m²/m and a cutoff of 450 D and a circulation pump g which generated circulation over the membrane. The connection to the reaction part was effected via the above-described crossflow chamber f.

The permeate flow through the membrane j was brought about by a pressure regulator F on the permeate side. This regulator made it possible to build up a pressure difference over the membrane area and thus produce a product flow i of aldehydes.

Before the start, the reaction system was pressurized five times with 2.0 MPa of synthesis gas CO/H₂ (1:1) and depressurized each time. The feed solution (1.9 M 1-butene in toluene) was then transferred by means of an HPLC pump from the above-described feed reservoir h into the experimental plant to 90% of the desired fill level. After start-up of the reactor circuit, the reaction part was heated to 80° C. and a pressure of 20 bar of CO/H₂ (1:1) was set. The reaction system was equilibrated for 1 hour before the catalytically active composition containing 15 mg (58 μmol) of Rh(acac)(CO)₂ and 815 mg (290 μmol) of the POSS-substituted PPh₃ according to the invention, corresponding to an L:Rh ratio of 5:1, in 14 ml of toluene was introduced via the above-described pressure burette a (t=0) under the reaction pressure. The catalyst solution was made up under an argon atmosphere. A differential pressure of 0.30 MPa was subsequently set at the membrane j by means of the permeate pressure regulator F in order to remove the product i, aldehydes, formed from the system. The amount of product i discharged was then replaced by feed solution from the reservoir h by means of the above-described level regulator B on the autoclave and the fill level in the reaction system was thus kept constant. The reaction was carried out for a period of 14 days; during this time, samples were taken and analyzed at regular intervals. The conversion of 1-octene and the regioselectivity (l/b ratio) were determined by means of GC analysis. Rh and P retentions by the membrane were determined by ICP-OES analysis of the permeate. Both the Rh losses and the P losses were very small. Based on the total amount of rhodium and phosphorus, these losses were 0.08% (Rh) and 0.95% (P).

Continuous hydroformylation experiment;
reactor/reaction specifications

| | |
|---|---|
| Reaction volume | 220 ml |
| Reaction temperature | 80° C. |
| Reaction pressure | 2.0 MPa CO/H₂ (1/1) |
| [Rh] | 0.28 mM |
| [1-Butene] | 1.9M |
| Solvent | Toluene |
| L:Rh | 5:1 |
| Reactor circulation | 0.45 l/min |
| Membrane circulation | 2.27 l/min |
| Membrane | Manufacturer = Inopor |
| | Material = TiO₂ |
| | Length = 200 mm |
| | di = 7 mm |
| | da = 10 mm |
| | Pore size = 0.9 nm |
| | Filtration area = 0.0217 m²/m |
| | cutoff = 450 D |
| TMP | 0.3 MPa |
| Permeate flow | 10 g/h |

Continuous hydroformylation of 1-Butene using POSS-
substituted PPh₃/Rh

| Sample | Time (min) | Yield (%) | l/b |
|---|---|---|---|
| 1 | 0 | 0 | |
| 2 | 10 | 0.5 | |
| 3 | 20 | 1.8 | |
| 4 | 30 | 6.1 | 2.9 |
| 5 | 40 | 9.4 | 3.0 |
| 6 | 50 | 13.5 | 3.1 |
| 7 | 60 | 17.8 | 3.0 |
| 8 | 90 | 27.8 | 3.0 |
| 9 | 120 | 38.1 | 2.9 |
| 10 | 180 | 58.4 | 3.0 |
| 11 | 240 | 70.7 | 2.9 |
| 12 | 300 | 82.4 | 2.9 |
| 13 | 360 | 85.9 | 2.9 |
| 14 | 720 | 92.0 | 2.8 |
| 15 | 1080 | 94.3 | 2.7 |
| 16 | 1200 | 94.3 | 2.8 |
| 17 | 1440 | 94.5 | 2.7 |
| 18 | 2880 | 95.6 | 2.6 |
| 19 | 4320 | 95.7 | 2.3 |
| 20 | 5760 | 95.4 | 2.4 |
| 21 | 8640 | 95.3 | 2.3 |
| 22 | 11520 | 95.8 | 2.3 |
| 23 | 14400 | 95.7 | 2.2 |
| 24 | 17280 | 95.0 | 2.4 |
| 25 | 20160 | 93.7 | 2.3 |
| 26 | 23040 | 92.8 | 2.3 |
| 27 | 25920 | 91.8 | 2.3 |
| 28 | 28800 | 89.4 | 2.3 |

In further embodiments of the invention relating to the use of POSS-modified ligands in catalytically active compositions in hydroformylation, use was made of, inter alia, raffinates such as raffinate I, raffinate II and also mixtures containing olefins having from 3 to 20 carbon atoms as olefin-containing mixtures.

1. An organic compound comprising phosphorus covalently bound to at least one polyhedral oligomeric silsesquioxane derivative, wherein the compound has a formula 1 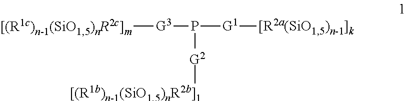
wherein (R^{1a,b,c})ₙ₋₁(SiO_{1.5})ₙR^{2a,b,c} are polyhedral oligomeric silsesquioxane derivatives in which n
is 8, and R^{1a}, R^{1b}, and R^{1c} are identical C₄-alkyl chains;
where k, l, and m are each 0 or 1, with the proviso that k+l+m≧1;
where R^{2a}, R^{2b}, R^{2c} are each a linkage between the polyhedral oligomeric silsesquioxane derivative and G1, G2 and/or and G3, respectively;
where R^{2a}, R^{2b}, and R^{2c} are identical C₂-alkyl chains; and
where G1, G2 and G3 are phenyl groups monovalently bound to phosphorus perfluoroalkylated, aromatic, heteroaromatic, fused aromatic, fused heteroaromatic units.

2-3. (canceled)

4. A catalytically active composition comprising the organic compound of claim 1 and at least one metal selected from group 8, 9 or 10 of the Periodic Table of the Elements.

5. The catalytically active composition of claim 4, wherein the metal is selected from group 9 of the Periodic Table of the Elements.

6. The catalytically active composition of claim 5, wherein the metal is rhodium.

7. A process for hydroformylation of an olefin-comprising mixture, the process comprising contacting the mixture with the catalytically active composition of claim 4.

8. The process of claim 7, wherein the mixture comprises an olefin having 3 to 20 carbon atoms.

9. The process of claim 8, wherein the mixture comprises one selected from the group consisting of propene, raffinate I, raffinate II, and raffinate III.

10. The process of claim 8, wherein the mixture comprises 1-butene.

11. The process of claim 8, wherein the mixture comprises 1-octene.

12. The process of claim 7, further comprising separating the catalytically active composition from a stream comprising a product, by organic nanofiltration without performing a thermal separation process.

13. A multiphase reaction mixture comprising:
a) an olefin having 3 to 20 carbon atoms,
b) a gas mixture comprising carbon monoxide and hydrogen,
c) an aldehyde, and
the catalytically active composition of claim 4.

14. The organic compound of claim 1, wherein k, l, and m are each 1.

15. The organic compound of claim 1, wherein R^{1a}, R^{1b} and R^{1c} are each isobutyl.

16. The organic compound of claim 1, wherein R^{2a}, R^{2b} and R^{2c} are each identical linear C₂-alkyl chains.

17. The process of claim 7, wherein the catalytically active composition comprises a metal selected from group 9 of the Periodic Table of the Elements.

18. The process of claim 7, wherein the catalytically active composition comprises rhodium.

19. The process of claim 17, wherein the mixture comprises 1-butene.

20. The process of claim 17, wherein the mixture comprises 1-octene.

21. The process of claim 18, wherein the mixture comprises 1-butene.

22. The process of claim 18, wherein the mixture comprises 1-octene.
